(19) United States
(12) Patent Application Publication
(10) Pub. No.: US 2004/0087673 A1
(43) Pub. Date: May 6, 2004

(54) Method for processing contaminated polycondensate materials

(76) Inventor: Kurt Muntener, Bad Salzuflen (DE)

Correspondence Address: DARBY & DARBY P.C., P. O. BOX 5257, NEW YORK, NY, 10150-5257, US

(21) Appl. No.: 10/450,235

(22) PCT Filed: Jan. 17, 2002
(86) PCT No.: PCT/CH02/00028

(30) Foreign Application Priority Data
Jan. 17, 2001 (DE) 101 02 063.7

(51) Int. Cl. C08J 11/04

(52) U.S. Cl. 521/48

(57) ABSTRACT

The invention relates to a method for processing contaminated polycondensate materials, especially polyethylene terephthalate (PET). The inventive method is characterized by removing a surface layer of the polycondensate material to be processed before the material is melted and filtered in the melt. Optionally, said method may be followed by a step for increasing the intrinsic viscosity by melt phase or solid phase polycondensation.

The invention relates to a method for processing contaminated polycondensate material, e.g., polyethylene terephthalate, used, for example, for disposable or reusable bottles.

During their service life, consumer products often come into contact with fine solid particles. This type of consumer product can consist of polycondensate, especially polyethylene terephthalate (PET), as used, for example, in bottles. If solid particles happen to get between some hard surface and a relative soft surface of a PET bottle, they can penetrate into the surface of the relatively soft wall of the bottle, or the bottom of the bottle due to the friction that takes place between the surfaces. These solid particles are then rigidly occluded in the surface of the bottle wall. A conventional washing procedure involving the use of a perpetually moving washing liquid containing at least one detergent is unable to remove these occluded particles from the surface of the PET bottles comminuted into chips.

The aim of numerous mechanical reprocessing procedures is to recycle used polycondensate material, e.g., PET bottles. These procedures normally involve steps for surface cleaning, melting and conversion to obtain a new product. When reusing areas of a bottle wall containing occluded particles to make new bottles, the particles cause defects in the material. Removing the larger particles via melt filtration as part of the mechanical reprocessing procedure is known in the art. In this case, filter sizes that remove particles measuring 60 micrometers or more are usually used. Some particularly fine filters can remove particles measuring 30 micrometers or more. However, these filters allow the extremely small particles through, and even though they cause no mechanical defects, they still yield optical defects that might be unacceptable for some bottle applications.

The use of even smaller filters is not desirable in a mechanical reprocessing procedure, since finer filters trigger a higher stagnation pressure for a filter of a given size, or require a larger filter surface, which in the end increases the retention time in the melt. Both contribute to a deterioration in quality of the polycondensate material in that the molecular weight is decreased and the polycondensate becomes discolored.

Melt filtration is therefore unsuitable for the removal of the extremely fine particles, in particular solid particles.

Therefore, the object of the invention is to provide a procedure in which even the extremely small particles that cannot be efficiently removed via conventional melt filtration while retaining the quality of the polycondensate material can be removed from the polycondensate material to be processed.

This object is achieved by the procedure according to claim 1.

The subclaims describe additional advantageous embodiments of the procedure according to the invention.

Removing the surface of the polycondensate material to be processed before melting extracts the fine particles occluded directly on and under the surface from the material, so that they no longer have to be removed with extremely fine filters.

In this case, it is particularly advantageous for the thickness of the removed surface layer of the polycondensate material to correspond to the maximum size of the occluded particles to be removed. This can be substantiated by the fact that a solid particle is only subjected to an external frictional force that presses it into the bottle wall until it has completely penetrated into the wall.

Since larger particles are removed via melt filtration, surface removal relates only to the occluded solid particles that are smaller than the smallest filter opening.

In particular, the surface layer removed prior to melting is about 15 to 30 micrometers thick. This corresponds to the smallest possible filter openings with which a melt filtration can be performed in conjunction with the surface removal without having to tolerate any inefficiency of the procedure and deterioration in quality of the polycondensate material.

It would in principle be enough to remove the surface of the entire bottle. However, it makes sense in most cases to comminute the bottles into chips or flakes prior to surface removal to facilitate handling and mechanical processing.

### EXAMPLE

Used PET bottles were comminuted into PET flakes or PET chips, washed and extruded, wherein use was made of a melt filter that retains particles starting at a size of 30 micrometers. The obtained extruded product contains 16 visible defects per 1000 m².

By adding a step to remove the surface of the comminuted and washed PET flakes or PET chips, the number of visible defects could be decreased to less than per 1 per 1000 m².

1. A method for the processing of used polycondensate material, in particular of polyethylene-terephthalate (PET) with the following steps:
Removal of a surface layer of the polycondensate material;
Melting of the polycondensate material; and
Increasing of the molecular weight of the polycondensate material,
characterised in that the thickness of the surface layer of the polycondensate material is essentially the same as the maximum size of the enclosed particles to be removed by surface removal.

2. The method according to one of the foregoing claims, characterised in that the used polycondensate material is a flock or shredded material, which is obtained by the comminution or milling of the consumer product.

3. The method according to one of the foregoing claims, characterized in that, after the melting of the pure polycondensate material a step of melt filtration is carried out, in order to remove any particles which have not melted which are contained in the essentially pure polycondensate material.

4. The method according to claim 3, characterised in that the thickness of the surface layer removed corresponds approximately to the size of the smallest filter apertures.

5. The method according to claim 4, characterised in that the thickness of the surface layer removed corresponds to approximately 15 to 30 micrometres.

6. The method according to one of the foregoing claims, characterised in that 0.2 to 20%, and for preference 2 to 6% of each surface is removed.

7. The method according to one of claims 3 to 6, characterised in that the filter has filter apertures of at least 20 micrometres.

8. The method according to one of the foregoing claims, characterised in that the used polycondensate material is a polyester.

9. The method according to one of the foregoing claims, characterised in that the used polycondensate material consists of PET bottles.

10. The method according to claim 8 or 9, characterised in that the intrinsic viscosity (IV measured by solution viscosity) of the polycondensate is raised by 0.02 or more above the initial intrinsic viscosity of the polyester.

11. The method according to claim 10, characterised in that the intrinsic viscosity is increased by melt-phase polycondensation.

12. The method according to claim 10, characterised in that the intrinsic viscosity is increased by solid-phase polycondensation.

13. The method according to claim 12, characterised in that the intrinsic viscosity is increased by continuous solid-phase polycondensation.

14. The method according to claim 12, characterised in that the intrinsic viscosity is increased after the polycondensate has been melted and solidified again.

15. The method according to claim, 12, characterised in that the intrinsic viscosity is increased before the polycondensate has been melted.
